(19) United States
(12) Patent Application Publication
(10) Pub. No.: US 2026/0080319 A1
(43) Pub. Date: Mar. 19, 2026

(54) MACHINE LEARNING TO AUTOMATE TRAINING DATA LABELING AND TRAINING FOR BENCHMARK MODEL

(71) Applicant: SAP SE, Walldorf (DE)

(72) Inventor: Deng Zhou, Neckargemund (DE)

(21) Appl. No.: 18/885,100

(22) Filed: Sep. 13, 2024

(51) Int. Cl. G06N 20/20

(52) U.S. Cl. CPC G06N 20/20

(57) ABSTRACT

In an example embodiment, a multi-level machine learning process is used to automate labelling data and training and fine-tuning a number of benchmarking classifier machine learning models. Automatic labeling is performed partially based on density and trends among data points in a training set. This approach may be used with different types of performance or telemetry data types.

### BACKGROUND

Enterprise Resource Planning (ERP) software integrates into a single system various processes used to run an organization, such as finance, manufacturing, human resources, supply chain, services, procurement, and others. These processes typically provide intelligence, visibility, and efficiency across most if not all aspects of an organization. One Example of ERP software is SAP® S/4 HANA from SAP SE of Walldorf, Germany.

ERP software is typically made up of multiple applications that share a single database.

### BRIEF DESCRIPTION OF DRAWINGS

The present disclosure is illustrated by way of example and not limitation in the figures of the accompanying drawings, in which like references indicate similar elements.

FIG. 1 is a block diagram illustrating an ERP system, in accordance with an example embodiment.

FIG. 2 is a diagram illustrating an in-memory database management system, including its client/external connection points, which can be kept stable in the case of disaster recovery to ensure stable service operations, in accordance with an example embodiment.

FIG. 3 is a block diagram illustrating two parts of a DVM application, in accordance with an example embodiment.

FIG. 4 is a flow diagram illustrating a method for automatically labeling training data for use by a machine learning algorithm to train a plurality of classifier machine learning models, in accordance with an example embodiment.

FIG. 5 is a flow diagram illustrating a method for executing the first approach, in accordance with an example embodiment.

FIG. 6 is a flow diagram illustrating a method for executing the second approach, in accordance with an example embodiment.

FIG. 7 is a block diagram illustrating a software architecture, which can be installed on any one or more of the devices described above.

FIG. 8 illustrates a diagrammatic representation of a machine in the form of a computer system within which a set of instructions may be executed for causing the machine to perform any one or more of the methodologies discussed herein.

### DETAILED DESCRIPTION

The description that follows discusses illustrative systems, methods, techniques, instruction sequences, and computing machine program products. In the following description, for purposes of explanation, numerous specific details are set forth in order to provide an understanding of various example embodiments of the present subject matter. It will be evident, however, to those skilled in the art, that various example embodiments of the present subject matter may be practiced without these specific details.

ERP systems typically provide various metrics to allow entities to monitor their organizations. Specifically, it is useful for entities to be able to tell when an anomaly occurs, whether it be, for example, an anomaly with the functioning of one of their systems or devices, an anomaly in how a process flow is operating, or an anomaly in how well a portion of their organization is performing. Anomalies can be spotted by not just comparing performance in some metric against historical performance of the organization, but also by comparing performance by one organization against performance by similar organizations, often called peers. The comparisons are called benchmarks.

Machine learning algorithms may be used to train machine learning models to perform such benchmark comparisons and identify anomalies in the metrics of an organization. However, such machine learning algorithms depend on training data including correct labels. Labeling such training data, can be time consuming and may be difficult or impossible for a human to perform in a reasonable amount of time. Additionally, labeling the data point requires domain knowledge, which makes the labeling process even more challenging.

In an example embodiment, a multi-level machine learning process is used to automate labeling data and training and fine-tuning a number of benchmarking classifier machine learning models. Automatic labeling is performed partially based on density and trends among data points in a training set. This approach may be used with different types of performance or telemetry data types.

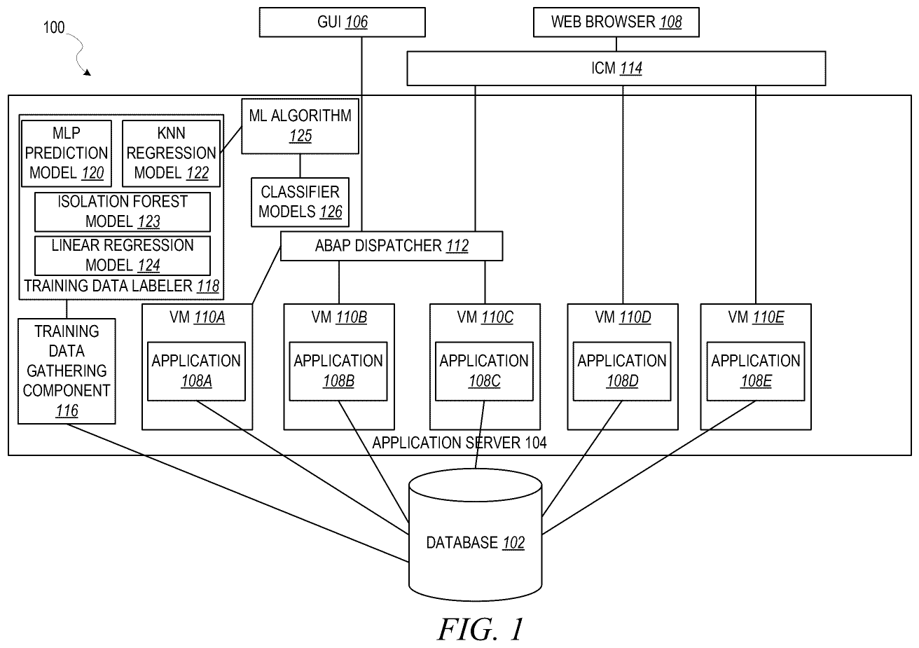

FIG. 1 is a block diagram illustrating an ERP system 100, in accordance with an example embodiment. The ERP system 100 may include a database 102, an application server 104, a graphical user interface (GUI) 106, and a web browser 108. The GUI 106 and the web browser 108 are alternative ways for a user to communicate with the application server 104. The database 102 and the application server 104 may be located on one or more servers in a cloud environment.

The application server 104 includes one or more ERP applications 108A-108E. Here, the applications 108A, 108B, 108C, 108D, 108E each run on their own virtual machine 110A, 110B, 110C, 110D, 110E, and may be accessed using commands in Advanced Business Application Programming (ABAP) language, via an ABAP dispatcher 112, or using commands in Java from an Internet Communication Manager (ICM) 114. Notably, all of the applications 108A-108E access the same database 102, which has a size. It is this size that the machine learned models of the present solution will attempt to predict.

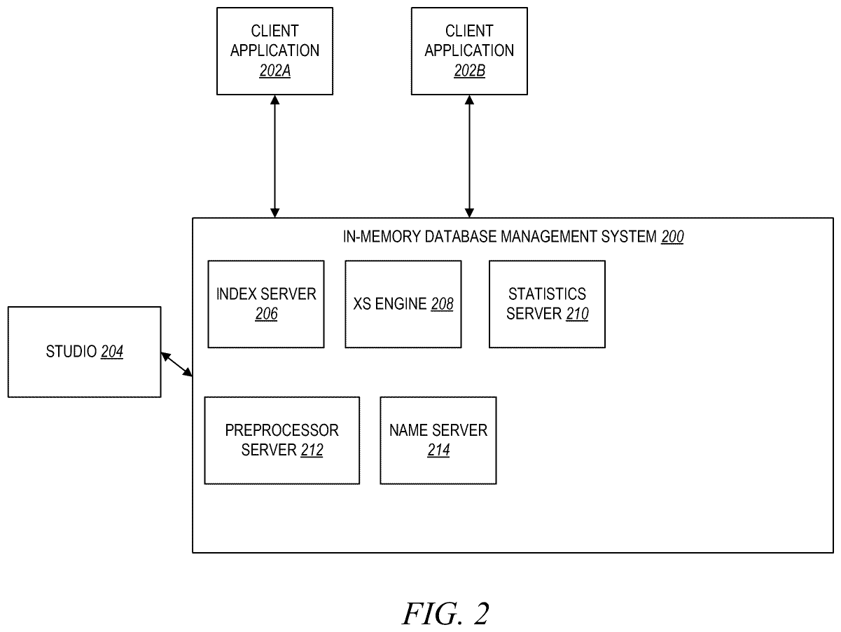

In some example embodiments the database 102 is an in-memory database. FIG. 2 is a diagram illustrating an in-memory database management system 200, including its client/external connection points, which can be kept stable in the case of disaster recovery to ensure stable service operations, in accordance with an example embodiment. It should be noted that one of ordinary skill in the art will recognize that sometimes an in-memory database management system 200 is also referred to as an in-memory database. Here, the in-memory database management system 200 may be coupled to one or more client applications 202A, 202B. The client applications 202A, 202B may communicate with the in-memory database management system 200 through a number of different protocols, including Structured Query Language (SQL), Multidimensional Expressions (MDX), Hypertext Transfer Protocol (HTTP), REST, and Hypertext Markup Language (HTML).

Also depicted is a studio 204, used to perform modeling or basic database access and operations management by accessing the in-memory database management system 200.

The in-memory database management system 200 may comprise a number of different components, including an index server 206, an XS engine 208, a statistics server 210, a preprocessor server 212, and a name server 214. These components may operate on a single computing device, or may be spread among multiple computing devices (e.g., separate servers).

The index server 206 contains the actual data and the engines for processing the data. It also coordinates and uses all the other servers.

The XS engine 208 allows clients to connect to the in-memory database management system 200 using web protocols, such as HTTP.

The statistics server 210 collects information about status, performance, and resource consumption from all the other server components. The statistics server 210 can be accessed from the studio 204 to obtain the status of various alert monitors.

The preprocessor server 212 is used for analyzing text data and extracting the information on which text search capabilities are based.

The name server 214 holds information about the database topology. This is used in a distributed system with instances of the database on different hosts. The name server 214 knows where the components are running and which data is located on which server.

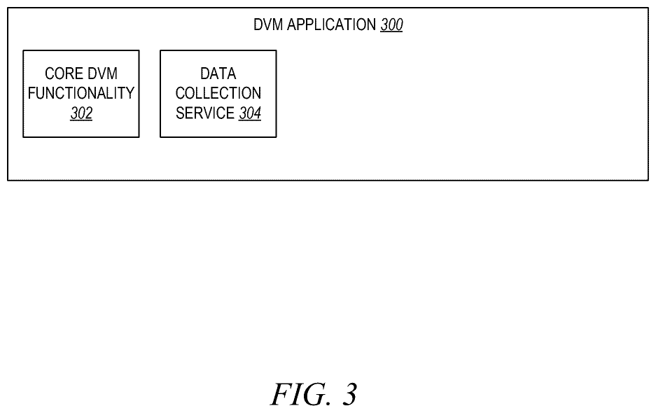

Referring back to FIG. 1, one of the applications 108A-108E is a DVM application. In an example embodiment, the DVM application is actually deployed over two different types of systems. The first is an ABAP system, such as that depicted in FIG. 1. The second is a cloud system. FIG. 3 is a block diagram illustrating a DVM application 300 in accordance with an example embodiment. The DVM application 300 includes a core DVM functionality 302 as well as a data collection service 304.

Referring back to FIG. 1, a training data gathering component 116 gathers training data from the database 102. This training data may include historical information relevant to a metric of interest, across multiple organizations. In an example embodiment, this training data includes telemetry performance information, such as organization identifier fields, categorical fields, and numeric measurement fields. The categorical fields include items such as organization industry, segment, or domain-specific fields such as service identification (if the training data includes performance key performance indices (KPIs) measured from different servers) and table name (if the training data includes size or growth-related KPIs per table).

The numerical measurement fields can include any KPI measurement, such as response time, job duration, disk size, etc.

A training data labeler 118 acts to label the training data gathered by the training data gathering component 116. As will be explained in more detail below, this training data labeler 118 uses an multilayer perceptron (MLP) prediction model 120, a K-nearest neighbor (KNN) regression model 122, an isolated forest model 123, and a linear regression model 124 to label the training data. The labeled training data is then fed to a machine learning algorithm 125, which uses the labeled training data to train a plurality of classifier models 126.

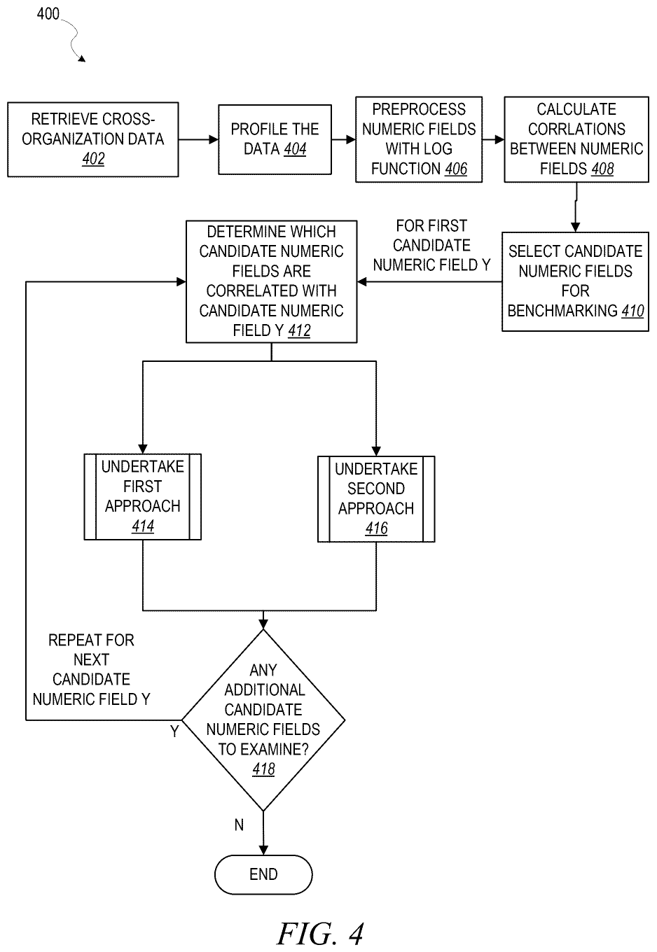

FIG. 4 is a flow diagram illustrating a method 400 for automatically labeling training data for use by a machine learning algorithm to train a plurality of classifier machine learning models, in accordance with an example embodiment. At operation 402, cross-organization data is retrieved, such as from an in-memory database or other storage device associated with an ERP system. At operation 404, the data is profiled. Profiling is a process of examining, analyzing, and creating useful summaries of data. This process yields a high-level overview which aids in the discovery of data quality issues, risks, and overall trends. This profiling allows the training data labeler 118 to determine whether each field of the training data is an identification field, a categorical field, or a numeric measurement field.

Each numeric field is then preprocessed with a log function at operation 406. The log function downgrades the corresponding data based on size (the larger the numeric value, the more it is downgraded). At operation 408, correlations between numeric fields are calculated. This sets up a correlation matrix between the fields. At operation 410, candidate numeric fields are selected for benchmarking. This may include, for example, excluding numeric fields that are empty.

A looping exploratory process is then executed. Here, for each candidate numeric field (y), at operation 412, it is determined which of the other candidate numeric fields is correlated with y. At operation 414, for those other candidate numeric fields that are correlated with y, a first approach is undertaken, using the MLP prediction model 120 and the KNN regression model 122. At operation 416, for those other candidate numeric fields that are not correlated with y, a second approach is undertaken. Either approach results in the training of a classifier model in the plurality of classifier models 126. In an example embodiment, these classifier models are random forest classifier models. More specifically, the classifier models are 3-class random forest classifier models, meaning that they classify data into one of three classes. Here the classes may be inlier, outlier, and uncertain.

At operation 418 it is determined whether there are any additional candidate numeric fields. If not, then the method 400 ends. If so, however, then the method loops back to operation 412 for the next candidate numeric field.

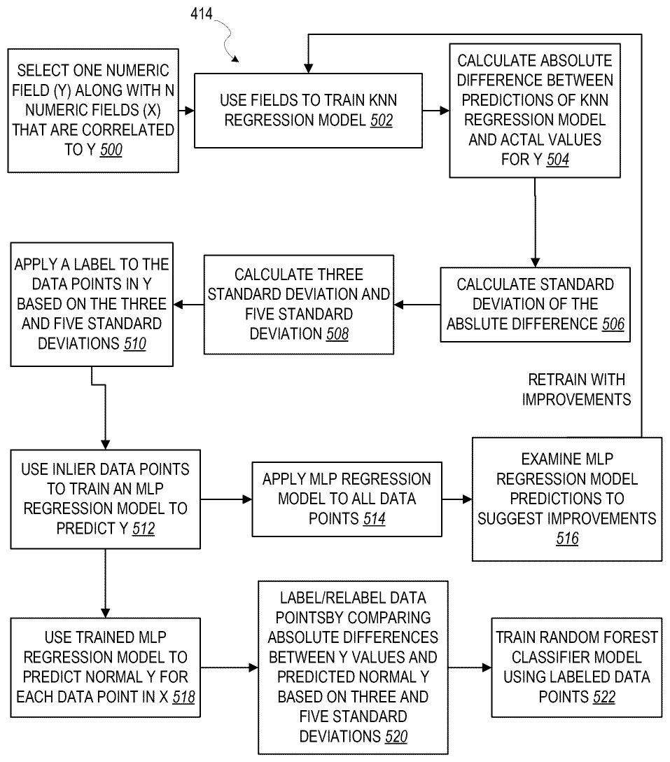

FIG. 5 is a flow diagram illustrating a method of operation 414 for executing the first approach, in accordance with an example embodiment. At operation 500, one numeric field (y) is selected along with n numeric fields (X) that are correlated to y (based on the correlation matrix). These selections are then used at operation 502 to train the KNN regression model 122 to predict a value for an input numeric column. In other words, it is trained to predict what y would be if y was not known. This may be rewritten as training to predict y_predict (as opposed to y_actual, which is the known value for y). At operation 504, the absolute difference (y_abs_diff) between y_actual and y_predict is calculated. At operation 506, the standard deviation of y_abs_diff is calculated. This allows the three standard deviation (3-sigma) and the five standard deviation (5-sigma) to be calculated at operation 508. Here, the three standard deviation is going to be used to differentiate between inlier and uncertain labels, while the five standard deviation is going to be used to differentiate between uncertain and outlier labels.

Then, at operation 510, a label is applied to the data points in y based on the three and five standard deviations. For example, if a value of a data point is within three standard deviations, then it is assigned a label of “inlier”. If the value of a data point is between three and five standard deviations, then it is assigned a label of “uncertain.” If the value of a data point is greater than five standard deviations, then it is assigned a label of “outlier.”

At operation 512, the data points with the label “inlier” are used to train an MLP regression model 120 to predict y. An MLP model is a specific type of feed-forward neural network where. In addition to an input and an output layer, it also comprises hidden layers that define a mapping of an input of the neural network to an output. The neurons in the hidden layers apply weights to the input data, process it through an activation function, and pass the result to the next layer. Hidden layers are responsible for learning and extracting features from the data. Feed-forward means that information flows in one direction, from the input layer through the hidden layers to the output layer, with no cycles or loops. The activation functions introduce non-linearity into the network, which helps the MLP learn complex patterns. Example activation functions include the sigmoid function, hyperbolic tangent, and rectified linear unit (ReLU).

Backpropagation is used to train the ML regression model 120. This involves calculating the gradient of the loss function with respect to each weight by applying the chain rule, and then updating the weights to minimize the error.

Notably, at this operation, only the inlier data points are used for the training. The uncertain or outlier data points are not used for this operation (though they will be used in the next operation).

At operation 514, the MLP regression model 120 is applied to all data points to predict y_mlp. This includes data points labeled as inlier, uncertain, or outlier. At operation 516, the y_mlp values are examined to evaluate the trained MLP regression model 120 and suggest improvements, with those improvements looping back to operation 502. Operations 500-516 thus can be considered a training portion, in which the MLP regression model 120 is trained, and also labels the data points based on densities. Then this model may be used to relabel the data points using the trained MLP regression model.

Thus, at operation 518, the trained MLP regression model 120 is used to predict y_mlp_normal for each data point in the X space (the fields correlated to y). Then, at operation 520, all the data points are labeled/relabeled (again as inlier, uncertain, or outlier) by comparing the absolute difference between y and y_mlp_normal with the three and five standard deviations.

At operation 522, a random forest classifier model is trained using the labeled data points. A random forest classifier model operates by creating many trees, with each tree having some randomness built into it. The random forest classifier model is then able to arrive at a decision by utilizing all of the predictions made by the many trees. For a classification task, the output of the random forest classifier model is, for example, the class selected by the most trees.

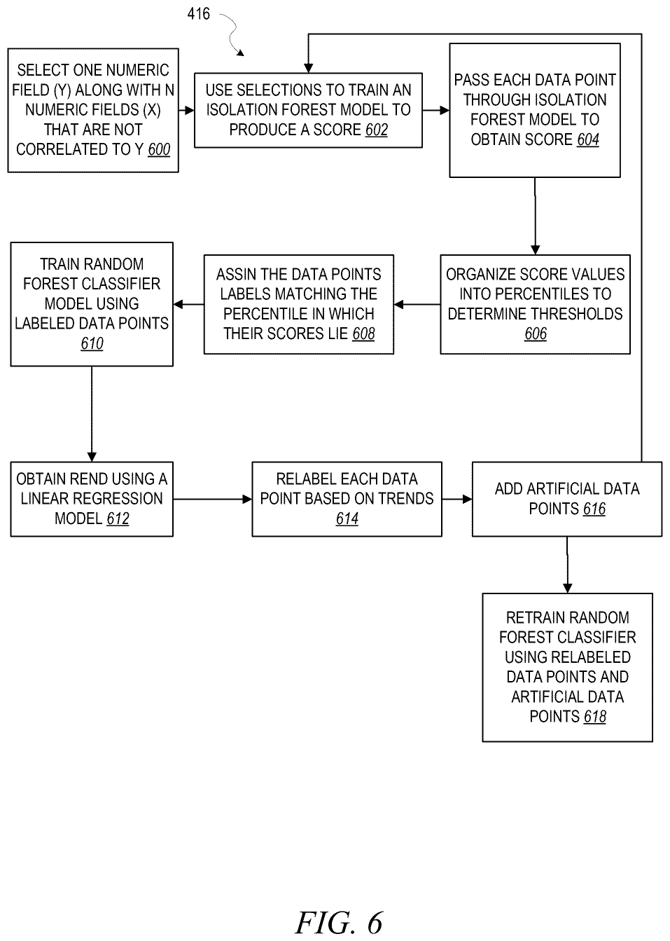

FIG. 6 is a flow diagram illustrating a method of operation 416 for executing the second approach, in accordance with an example embodiment. At operation 600, one numeric field (y) is selected along with n numeric fields (X) that are not correlated to y (based on the correlation matrix). These selections are then used at operation 602 to train an isolation forest model 123 to produce a score indicative of how close a point is to other points. Here, unlike with the first approach, the score is based on percentiles because the fields are not correlated to each other, and hence, data points tend to be more spread out.

More specifically, once the isolation forest model 123 is trained, at operation 604, each data point is passed through the model to obtain the score. At operation 606, the score values are then organized into percentiles to determine thresholds acting as boundaries between the label classifications. More particularly, three different percentiles may be established. Data points with scores in the top percentile may be labeled “inlier”. Data points with scores in the middle percentile may be labeled “uncertain”. Data points with scores in the bottom percentile may be labeled “outlier”. At operation 608, the data points are then assigned labels matching the percentile in which their scores lie.

At this point, at operation 610, a random forest classifier model is trained using the labeled data points. At operation 612, a trend of X to y is obtained using a linear regression model 124. The linear regression model 124 may be trained using the inlier data points to predict trends. At operation 614, each data point is relabeled based on the trends. More particularly, for example, if a data point was labeled as uncertain but it is below a trend line for inlier, then it may be relabeled as an inlier.

Additionally, because the fields are not correlated or have only minor correlation, there is a lot of uncertainty. As such, at operation 616 artificial data points are added with an uncertainty label (above the trend line) to influence the classifier training to acknowledge and factor in this uncertainty. Finally, at operation 618 the random forest classifier model is retrained based on the relabeled data points and the artificial data points.

In view of the above-described implementations of subject matter, this application discloses the following list of examples, wherein one feature of an example in isolation or more than one feature of said example taken in combination and, optionally, in combination with one or more features of one or more further examples are further examples also falling within the disclosure of this application: Example 1 is a system comprising: at least one hardware processor; and a computer-readable medium storing instructions that, when executed by the at least one hardware processor, cause the at least one hardware processor to perform operations comprising: accessing training data comprising a plurality of different data points over different numeric fields Y; calculating correlations among the numeric fields Y; for a first numeric field y of the numeric fields Y and for a plurality of numeric fields X, within Y, correlated with y, feeding y and X into a machine learning algorithm to train a k-nearest neighbor regression model to predict a value for y; for each of a plurality of data points: predicting a corresponding value for y using the k-nearest neighbor regression model; calculating an absolute difference between the predicted corresponding value for y and an actual value for y of a corresponding data point; labeling the corresponding data point as an inlier, outlier, or uncertain based on the absolute difference between the predicted corresponding value for y and an actual value for y; feeding data points labeled as inlier, but not data points labeled as uncertain or outlier, into a second machine learning model to train a multilayer perceptron (MLP) regression model to predict a value for y; relabeling each data point in X based on a prediction by the multilayer perceptron regression model for each data point in X; and passing the labeled data points to a third machine learning model to train a first random forest classifier model.

In Example 2, the subject matter of Example 1 comprises, wherein the operations further comprise: profiling the training data to divide the training data into data having the numeric fields, data having categorical fields, and data having identification fields.

In Example 3, the subject matter of Examples 1-2 comprises, wherein the operations further comprise: preprocessing data points of the numeric fields by applying a log function to the data points of the numeric fields.

In Example 4, the subject matter of Examples 1-3 comprises, wherein the calculating correlations produces a correlation matrix.

In Example 5, the subject matter of Examples 1-4 comprises, wherein the operations further comprise: feeding data points labeled during the labeling operation to the MLP regression model to predict a value for y for each data point labeled during the labeling operation; identifying a model improvement by evaluating the predicted values for y from the MLP regression model; and retraining the k-nearest neighbors regression model based on the model improvement.

In Example 6, the subject matter of Examples 1-5 comprises, wherein the relabeling comprises: calculating a standard deviation of the absolute differences between the predicted corresponding value for y and an actual value for y of the corresponding data points; calculating a three standard deviation and a five standard deviation from the standard deviation; and labeling each data point as either an inlier, uncertain, or outlier based on whether its corresponding absolute difference is below the three standard deviation, between the three standard deviation and the five standard deviation, or above the five standard deviation.

In Example 7, the subject matter of Examples 1-6 comprises, wherein the operations further comprise: for a first numeric field y′ of the numeric fields and for a plurality of numeric fields X′, of the numeric fields, not correlated with y′, feeding y′ and X′ into a fourth machine learning algorithm to train an isolation forest model to output a score indicative of how close a data point is to other data points; labeling each data point in y′ or X′ based on comparison of a corresponding score from the isolation forest model to percentiles of scores from the isolation forest model; passing the labeled data points in y′ or X′ to a fifth machine learning model to train a second random forest classifier model; using a linear regression model to obtain a trend of X′ to y′; relabeling the labeled data points based on the trend; and retraining the second random forest classifier model using the relabeled labeled data point in y′or X′.

In Example 8, the subject matter of Example 7 comprises, wherein the operations further comprise: generating artificial data points, having values above the trend, with uncertain labels; and wherein the retraining comprises retraining the second random forest classifier model using the relabeled labeled data point in y'or X′ and the artificial data points.

Example 9 is a method comprising: accessing training data comprising a plurality of different data points over different numeric fields Y; calculating correlations among the numeric fields Y; for a first numeric field y of the numeric fields Y and for a plurality of numeric fields X, within Y, correlated with y, feeding y and X into a machine learning algorithm to train a k-nearest neighbor regression model to predict a value for y; for each of a plurality of data points: predicting a corresponding value for y using the k-nearest neighbor regression model; calculating an absolute difference between the predicted corresponding value for y and an actual value for y of a corresponding data point; labeling the corresponding data point as an inlier, outlier, or uncertain based on the absolute difference between the predicted corresponding value for y and an actual value for y; feeding data points labeled as inlier, but not data points labeled as uncertain or outlier, into a second machine learning model to train a multilayer perceptron (MLP) regression model to predict a value for y; relabeling each data point in X based on a prediction by the multilayer perceptron regression model for each data point in X; and passing the labeled data points to a third machine learning model to train a first random forest classifier model. In Example 10, the subject matter of Example 9 comprises, profiling the training data to divide the training data into data having the numeric fields, data having categorical fields, and data having identification fields.

In Example 11, the subject matter of Examples 9-10 comprises, preprocessing data points of the numeric fields by applying a log function to the data points of the numeric fields.

In Example 12, the subject matter of Examples 9-11 comprises, wherein the calculating correlations produces a correlation matrix.

In Example 13, the subject matter of Examples 9-12 comprises, feeding data points labeled during the labeling operation to the MLP regression model to predict a value for y for each data point labeled during the labeling; identifying a model improvement by evaluating the predicted values for y from the MLP regression model; and retraining the k-nearest neighbors regression model based on the model improvement.

In Example 14, the subject matter of Examples 9-13 comprises, calculating a standard deviation of the absolute differences between the predicted corresponding value for y and an actual value for y of the corresponding data points; calculating a three standard deviation and a five standard deviation from the standard deviation; and labeling each data point as either an inlier, uncertain, or outlier based on whether its corresponding absolute difference is below the three standard deviation, between the three standard deviation and the five standard deviation, or above the five standard deviation.

In Example 15, the subject matter of Examples 9-14 comprises, for a first numeric field y′ of the numeric fields and for a plurality of numeric fields X′, of the numeric fields, not correlated with y', feeding y′ and X′ into a fourth machine learning algorithm to train an isolation forest model to output a score indicative of how close a data point is to other data points; labeling each data point in y′ or X′ based on comparison of a corresponding score from the isolation forest model to percentiles of scores from the isolation forest model; passing the labeled data points in y′ or X′ to a fifth machine learning model to train a second random forest classifier model; using a linear regression model to obtain a trend of X′ to y′; relabeling the labeled data points based on the trend; and retraining the second random forest classifier model using the relabeled labeled data point in y′or X′.

In Example 16, the subject matter of Example 15 comprises, generating artificial data points, having values above the trend, with uncertain labels; and wherein the retraining comprises retraining the second random forest classifier model using the relabeled labeled data point in y'or X′ and the artificial data points.

Example 17 is a non-transitory machine-readable medium storing instructions which, when executed by one or more processors, cause the one or more processors to perform operations comprising: accessing training data comprising a plurality of different data points over different numeric fields Y; calculating correlations among the numeric fields Y; for a first numeric field y of the numeric fields Y and for a plurality of numeric fields X, within Y, correlated with y, feeding y and X into a machine learning algorithm to train a k-nearest neighbor regression model to predict a value for y; for each of a plurality of data points: predicting a corresponding value for y using the k-nearest neighbor regression model; calculating an absolute difference between the predicted corresponding value for y and an actual value for y of a corresponding data point; labeling the corresponding data point as an inlier, outlier, or uncertain based on the absolute difference between the predicted corresponding value for y and an actual value for y; feeding data points labeled as inlier, but not data points labeled as uncertain or outlier, into a second machine learning model to train a multilayer perceptron (MLP) regression model to predict a value for y; relabeling each data point in X based on a prediction by the multilayer perceptron regression model for each data point in X; and passing the labeled data points to a third machine learning model to train a first random forest classifier model. In Example 18, the subject matter of Example 17 comprises, wherein the operations further comprise: profiling the training data to divide the training data into data having the numeric fields, data having categorical fields, and data having identification fields.

In Example 19, the subject matter of Examples 17-18 comprises, wherein the operations further comprise: preprocessing data points of the numeric fields by applying a log function to the data points of the numeric fields.

In Example 20, the subject matter of Examples 17-19 comprises, wherein the calculating correlations produces a correlation matrix.

Example 21 is at least one machine-readable medium comprising instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

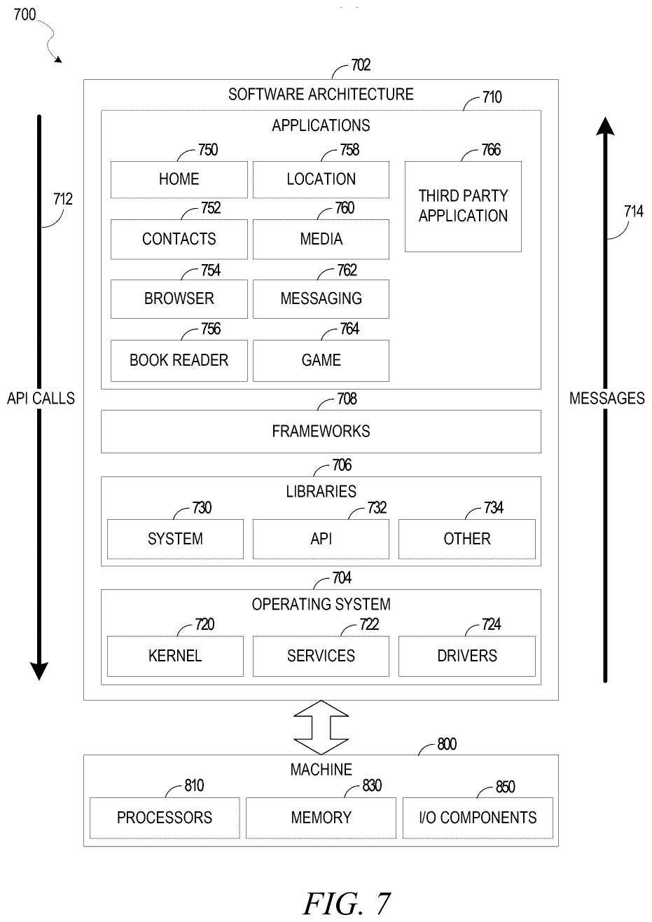

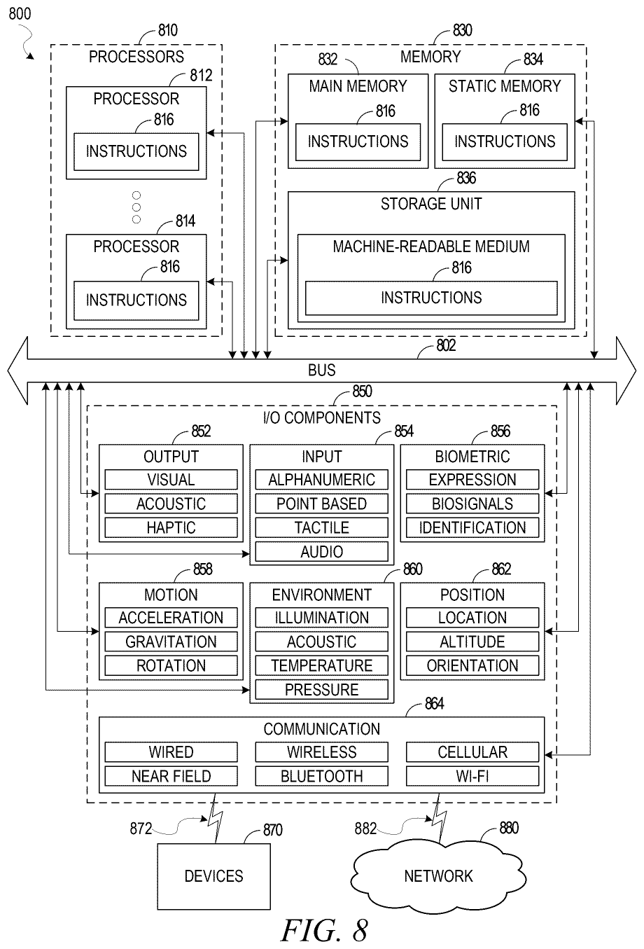

FIG. 7 is a block diagram 700 illustrating a software architecture 702, which can be installed on any one or more of the devices described above. FIG. 7 is merely a non-limiting example of a software architecture, and it will be appreciated that many other architectures can be implemented to facilitate the functionality described herein. In various embodiments, the software architecture 702 is implemented by hardware such as a machine 800 of FIG. 8 that includes processors 810, memory 830, and input/output (I/O) components 850. In this example architecture, the software architecture 702 can be conceptualized as a stack of layers where each layer may provide a particular functionality. For example, the software architecture 702 includes layers such as an operating system 704, libraries 706, frameworks 708, and applications 710. Operationally, the applications 710 invoke Application Program Interface (API) calls 712 through the software stack and receive messages 714 in response to the API calls 712, consistent with some embodiments.

In various implementations, the operating system 704 manages hardware resources and provides common services. The operating system 704 includes, for example, a kernel 720, services 722, and drivers 724. The kernel 720 acts as an abstraction layer between the hardware and the other software layers, consistent with some embodiments. For example, the kernel 720 provides memory management, processor management (e.g., scheduling), component management, networking, and security settings, among other functionality. The services 722 can provide other common services for the other software layers. The drivers 724 are responsible for controlling or interfacing with the underlying hardware. For instance, the drivers 724 can include display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 706 provide a low-level common infrastructure utilized by the applications 710. The libraries 706 can include system libraries 730 (e.g., C standard library) that can provide functions such as memory allocation functions, string manipulation functions, mathematic functions, and the like. In addition, the libraries 706 can include API libraries 732 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two-dimensional (2D) and three-dimensional (3D) in a graphic context on a display), database libraries (e.g., SQLite to provide various relational database functions), web libraries (e.g., WebKit to provide web browsing functionality), and the like. The libraries 706 can also include a wide variety of other libraries 734 to provide many other APIs to the applications 710.

The frameworks 708 provide a high-level common infrastructure that can be utilized by the applications 710. For example, the frameworks 708 provide various graphical user interface (GUI) functions, high-level resource management, high-level location services, and so forth. The frameworks 708 can provide a broad spectrum of other APIs that can be utilized by the applications 710, some of which may be specific to a particular operating system 704 or platform.

In an example embodiment, the applications 710 include a home application 750, a contacts application 752, a browser application 754, a book reader application 756, a location application 758, a media application 760, a messaging application 762, a game application 764, and a broad assortment of other applications, such as a third-party application 766. The applications 710 are programs that execute functions defined in the programs. Various programming languages can be employed to create one or more of the applications 710, structured in a variety of manners, such as object-oriented programming languages (e.g., Objective-C, Java, or C++) or procedural programming languages (e.g., C or assembly language). In a specific example, the third-party application 766 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 766 can invoke the API calls 712 provided by the operating system 704 to facilitate the functionality described herein.

FIG. 8 illustrates a diagrammatic representation of a machine 800 in the form of a computer system within which a set of instructions may be executed for causing the machine 800 to perform any one or more of the methodologies discussed herein. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. For example, the instructions 816 may cause the machine 800 to execute the methods of FIGS. 4-6. Additionally, or alternatively, the instructions 816 may implement FIGS. 1-6 and so forth. The instructions 816 transform the general, non-programmed machine 800 into a particular machine 800 programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

The machine 800 may include processors 810, memory 830, and I/O components 850, which may be configured to communicate with each other such as via a bus 802. In an example embodiment, the processors 810 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 812 and a processor 814 that may execute the instructions 816. The term “processor” is intended to include multi-core processors that may comprise two or more independent processors (sometimes referred to as “cores”) that may execute instructions 816 contemporaneously. Although FIG. 8 shows multiple processors 810, the machine 800 may include a single processor 812 with a single core, a single processor 812 with multiple cores (e.g., a multi-core processor 812), multiple processors 812, 814 with a single core, multiple processors 812, 814 with multiple cores, or any combination thereof.

The memory 830 may include a main memory 832, a static memory 834, and a storage unit 836, each accessible to the processors 810 such as via the bus 802. The main memory 832, the static memory 834, and the storage unit 836 store the instructions 816 embodying any one or more of the methodologies or functions described herein. The instructions 816 may also reside, completely or partially, within the main memory 832, within the static memory 834, within the storage unit 836, within at least one of the processors 810 (e.g., within the processor's cache memory), or any suitable combination thereof, during execution thereof by the machine 800.

The I/O components 850 may include a wide variety of components to receive input, provide output, produce output, transmit information, exchange information, capture measurements, and so on. The specific I/O components 850 that are included in a particular machine will depend on the type of machine. For example, portable machines such as mobile phones will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion, and the grouping is in no way limiting. In various example embodiments, the I/O components 850 may include output components 852 and input components 854. The output components 852 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 850 may include biometric components 856, motion components 858, environmental components 860, or position components 862, among a wide array of other components. For example, the biometric components 856 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 862 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 850 may include communication components 864 operable to couple the machine 800 to a network 880 or devices 870 via a coupling 882 and a coupling 872, respectively. For example, the communication components 864 may include a network interface component or another suitable device to interface with the network 880. In further examples, the communication components 864 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 870 may be another machine or any of a wide variety of peripheral devices (e.g., coupled via a USB).

Moreover, the communication components 864 may detect identifiers or include components operable to detect identifiers. For example, the communication components 864 may include radio-frequency identification (RFID) tag reader components, NFC smart tag detection components, optical reader components (e.g., an optical sensor to detect one-dimensional bar codes such as Universal Product Code (UPC) bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 864, such as location via Internet Protocol (IP) geolocation, location via Wi-Fi® signal triangulation, location via detecting an NFC beacon signal that may indicate a particular location, and so forth.

The various memories (i.e., 830, 832, 834, and/or memory of the processor(s) 810) and/or the storage unit 836 may store one or more sets of instructions 816 and data structures (e.g., software) embodying or utilized by any one or more of the methodologies or functions described herein. These instructions (e.g., the instructions 816), when executed by the processor(s) 810, cause various operations to implement the disclosed embodiments.

As used herein, the terms “machine-storage medium,” “device-storage medium,” and “computer-storage medium” mean the same thing and may be used interchangeably. The terms refer to single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 880 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 880 or a portion of the network 880 may include a wireless or cellular network, and the coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 816 may be transmitted or received over the network 880 using a transmission medium via a network interface device (e.g., a network interface component included in the communication components 864) and utilizing any one of a number of well-known transfer protocols (e.g., Hypertext Transfer Protocol [HTTP]). Similarly, the instructions 816 may be transmitted or received using a transmission medium via the coupling 872 (e.g., a peer-to-peer coupling) to the devices 870. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 816 for execution by the machine 800, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
at least one hardware processor; and
a computer-readable medium storing instructions that, when executed by the at least one hardware processor, cause the at least one hardware processor to perform operations comprising:
accessing training data comprising a plurality of different data points over different numeric fields Y;
calculating correlations among the numeric fields Y;
for a first numeric field y of the numeric fields Y and for a plurality of numeric fields X, within Y, correlated with y, feeding y and X into a machine learning algorithm to train a k-nearest neighbor regression model to predict a value for y;
for each of a plurality of data points:
predicting a corresponding value for y using the k-nearest neighbor regression model;
calculating an absolute difference between the predicted corresponding value for y and an actual value for y of a corresponding data point;
labeling the corresponding data point as an inlier, outlier, or uncertain based on the absolute difference between the predicted corresponding value for y and an actual value for y;
feeding data points labeled as inlier, but not data points labeled as uncertain or outlier, into a second machine learning model to train a multilayer perceptron (MLP) regression model to predict a value for y;
relabeling each data point in X based on a prediction by the multilayer perceptron regression model for each data point in X; and
passing the labeled data points to a third machine learning model to train a first random forest classifier model.

2. The system of claim 1, wherein the operations further comprise:
profiling the training data to divide the training data into data having the numeric fields, data having categorical fields, and data having identification fields.

3. The system of claim 1, wherein the operations further comprise:
preprocessing data points of the numeric fields by applying a log function to the data points of the numeric fields.

4. The system of claim 1, wherein the calculating correlations produces a correlation matrix.

5. The system of claim 1, wherein the operations further comprise:
feeding data points labeled during the labeling operation to the MLP regression model to predict a value for y for each data point labeled during the labeling operation;
identifying a model improvement by evaluating the predicted values for y from the MLP regression model; and
retraining the k-nearest neighbors regression model based on the model improvement.

6. The system of claim 1, wherein the relabeling comprises:
calculating a standard deviation of the absolute differences between the predicted corresponding value for y and the actual value for y of the corresponding data points;
calculating a three standard deviation and a five standard deviation from the standard deviation; and
labeling each data point as either an inlier, uncertain, or outlier based on whether its corresponding absolute difference is below the three standard deviation, between the three standard deviation and the five standard deviation, or above the five standard deviation.

7. The system of claim 1, wherein the operations further comprise:
for a first numeric field y′ of the numeric fields and for a plurality of numeric fields X′, of the numeric fields, not correlated with y′, feeding y′ and X′ into a fourth machine learning algorithm to train an isolation forest model to output a score indicative of how close a data point is to other data points;
labeling each data point in y′ or X′ based on comparison of a corresponding score from the isolation forest model to percentiles of scores from the isolation forest model;
passing the labeled data points in y′ or X′ to a fifth machine learning model to train a second random forest classifier model;
using a linear regression model to obtain a trend of X′ to y′;
relabeling the labeled data points based on the trend; and
retraining the second random forest classifier model using the relabeled labeled data point in y′or X′.

8. The system of claim 7, wherein the operations further comprise:
generating artificial data points, having values above the trend, with uncertain labels; and
wherein the retraining comprises retraining the second random forest classifier model using the relabeled labeled data point in y′or X′ and the artificial data points.

9. A method comprising:
accessing training data comprising a plurality of different data points over different numeric fields Y;
calculating correlations among the numeric fields Y;
for a first numeric field y of the numeric fields Y and for a plurality of numeric fields X, within Y, correlated with y, feeding y and X into a machine learning algorithm to train a k-nearest neighbor regression model to predict a value for y;
for each of a plurality of data points:
predicting a corresponding value for y using the k-nearest neighbor regression model;
calculating an absolute difference between the predicted corresponding value for y and an actual value for y of a corresponding data point;
labeling the corresponding data point as an inlier, outlier, or uncertain based on the absolute difference between the predicted corresponding value for y and an actual value for y;
feeding data points labeled as inlier, but not data points labeled as uncertain or outlier, into a second machine learning model to train a multilayer perceptron (MLP) regression model to predict a value for y;
relabeling each data point in X based on a prediction by the multilayer perceptron regression model for each data point in X; and
passing the labeled data points to a third machine learning model to train a first random forest classifier model.

10. The method of claim 9, further comprising:
profiling the training data to divide the training data into data having the numeric fields, data having categorical fields, and data having identification fields.

11. The method of claim 9, further comprising:
preprocessing data points of the numeric fields by applying a log function to the data points of the numeric fields.

12. The method of claim 9, wherein the calculating correlations produces a correlation matrix.

13. The method of claim 9, further comprising:
feeding data points labeled during the labeling to the MLP regression model to predict a value for y for each data point labeled during the labeling;
identifying a model improvement by evaluating the predicted values for y from the MLP regression model; and
retraining the k-nearest neighbors regression model based on the model improvement.

14. The method of claim 9, further comprising:
calculating a standard deviation of the absolute differences between the predicted corresponding value for y and an actual value for y of the corresponding data points;
calculating a three standard deviation and a five standard deviation from the standard deviation; and
labeling each data point as either an inlier, uncertain, or outlier based on whether its corresponding absolute difference is below the three standard deviation, between the three standard deviation and the five standard deviation, or above the five standard deviation.

15. The method of claim 9, further comprising:
for a first numeric field y′ of the numeric fields and for a plurality of numeric fields X′, of the numeric fields, not correlated with y′, feeding y′ and X′ into a fourth machine learning algorithm to train an isolation forest model to output a score indicative of how close a data point is to other data points;
labeling each data point in y′ or X′ based on comparison of a corresponding score from the isolation forest model to percentiles of scores from the isolation forest model;
passing the labeled data points in y′ or X′ to a fifth machine learning model to train a second random forest classifier model;
using a linear regression model to obtain a trend of X′ to y′;
relabeling the labeled data points based on the trend; and
retraining the second random forest classifier model using the relabeled labeled data point in y′or X′.

16. The method of claim 15, further comprising:
generating artificial data points, having values above the trend, with uncertain labels; and
wherein the retraining comprises retraining the second random forest classifier model using the relabeled labeled data point in y′or X′ and the artificial data points.

17. A non-transitory machine-readable medium storing instructions which, when executed by one or more processors, cause the one or more processors to perform operations comprising:
accessing training data comprising a plurality of different data points over different numeric fields Y;
calculating correlations among the numeric fields Y;
for a first numeric field y of the numeric fields Y and for a plurality of numeric fields X, within Y, correlated with y, feeding y and X into a machine learning algorithm to train a k-nearest neighbor regression model to predict a value for y;
for each of a plurality of data points:
predicting a corresponding value for y using the k-nearest neighbor regression model;
calculating an absolute difference between the predicted corresponding value for y and an actual value for y of a corresponding data point;
labeling the corresponding data point as an inlier, outlier, or uncertain based on the absolute difference between the predicted corresponding value for y and an actual value for y;
feeding data points labeled as inlier, but not data points labeled as uncertain or outlier, into a second machine learning model to train a multilayer perceptron (MLP) regression model to predict a value for y;
relabeling each data point in X based on a prediction by the multilayer perceptron regression model for each data point in X; and
passing the labeled data points to a third machine learning model to train a first random forest classifier model.

18. The non-transitory machine-readable medium of claim 17, wherein the operations further comprise:
profiling the training data to divide the training data into data having the numeric fields, data having categorical fields, and data having identification fields.

19. The non-transitory machine-readable medium of claim 17, wherein the operations further comprise:
preprocessing data points of the numeric fields by applying a log function to the data points of the numeric fields.

20. The non-transitory machine-readable medium of claim 17, wherein the calculating correlations produces a correlation matrix.
